(19) United States
(12) Patent Application Publication
(10) Pub. No.: US 2020/0049663 A1
(43) Pub. Date: Feb. 13, 2020

(54) ULTRASONIC INSPECTION METHOD AND ULTRASONIC INSPECTION DEVICE

(71) Applicant: YAMAHA FINE TECHNOLOGIES CO., LTD., Hamamatsu-shi (JP)

(72) Inventor: Akihiro NARA, Hamamatsu-shi (JP)

(21) Appl. No.: 16/535,525

(22) Filed: Aug. 8, 2019

(30) Foreign Application Priority Data
Aug. 10, 2018 (JP) 2018-151644

(51) Int. Cl. G01N 29/04; G01N 29/27; G01N 29/12

(52) U.S. Cl. CPC G01N 29/043; G01N 29/27; G01N 29/12; G01N 2291/048; G01N 2291/102; G01N 2291/0289; G01N 2291/0231

(57) ABSTRACT

An ultrasonic inspection method is a method for inspecting an inspection object including sheet members having peripheral portions. The peripheral portions are joined together at a first location. The sheet members are not joined together at a second location which is adjacent to the first location. The ultrasonic inspection method includes: outputting ultrasonic waves to an inspection target region in the peripheral portions, the inspection target region being set according to a boundary line between the first location and the second location; and receiving the ultrasonic waves that have passed through the inspection target region.

### CROSS-REFERENCE TO RELATED APPLICATION

Priority is claimed on Japanese Patent Application No. 2018-151644, filed Aug. 10, 2018, the content of which is incorporated herein by reference.

### BACKGROUND OF THE INVENTION

### Field of the Invention

The present invention relates to an ultrasonic inspection method and an ultrasonic inspection device for inspecting the presence or absence of peeling at a joined location in a packaging container formed by, for example, joining sheet members.

### Description of Related Art

Conventionally, prepackaged food, drinking water and the like are enclosed in pouch-type packaging containers in a sealed state. The packaging container is formed into a bag shape by joining peripheral edge portions of sheet members (including a film member) by welding, adhesion or the like. After the contents are accommodated inside the container, the opening is closed. Since there is a risk of the contents contained in such a packaging container leaking out if peeling occurs at a joined location, the joined location is inspected at the manufacturing stage.

For example, an ultrasonic inspection device is used in such an inspection. The ultrasonic inspection device transmits ultrasonic waves to the packaging container (workpiece) to be inspected, receives and analyzes the ultrasonic waves that have passed through the packaging container, and thereby determines whether or not peeling has occurred at the joined location.

In the vicinity of the boundary between the joined location and the non-joined location of the packaging container, the contents may be sandwiched therebetween, leading to peeling. Peeling near the boundary leads to deterioration in the quality of the contents, and since the appearance also suffers, it is desirable to detect all peeling points.

When ultrasonic waves are transmitted to a location near the end of the packaging container, diffracted waves may be generated as a result of the transmitted ultrasonic waves wrapping around the outer side of the end. Reception of such diffracted waves by the ultrasonic inspection device could contribute to an erroneous determination with regard to whether or not peeling has occurred.

As a countermeasure, a technique for preventing reception of diffracted waves in ultrasonic inspection has been proposed (see, for example, U.S. Pat. No. 6,840,108, hereinafter referred to as Patent Document 1). In Patent Document 1, by covering the end of the packaging container with a shield member, diffracted waves do not occur when ultrasonic waves are transmitted to a location near the end of the packaging container.

However, in food product inspection, it is necessary to carry out inspection on all products, and so it is desirable for the inspection time for each inspection object to not be long. Moreover, the work of covering the end of the packaging container with a shield member as a countermeasure against diffraction waves takes time and effort. In addition, in the case of a packaging container in which the outer shape of the peripheral edge portion is complicated, the work of covering the end may be difficult.

### SUMMARY OF THE INVENTION

The present invention has been achieved in view of the above circumstances. An exemplary object of the present invention is to provide an ultrasonic inspection method and an ultrasonic inspection device capable of inspecting for peeling at a joined portion of an inspection object without prolonging the inspection time.

In an aspect of the present invention an ultrasonic inspection method is a method for inspecting an inspection object including sheet members having peripheral portions. The peripheral portions is joined together at a first location. The sheet members are not joined together at a second location which is adjacent to the first location. The ultrasonic inspection method includes: outputting ultrasonic waves to an inspection target region in the peripheral portions, the inspection target region being set according to a boundary line between the first location and the second location; and receiving the ultrasonic waves that have passed through the inspection target region.

In another aspect of the present invention, an ultrasonic inspection device is a device for inspecting an inspection object including sheet members having peripheral portions. The peripheral portions are joined together at a first location. The sheet members are not joined together at a second location which is adjacent to the first location. The ultrasonic inspection device includes: a transmitter that outputs ultrasonic waves to an inspection target region in the peripheral portions, the inspection target region being set according to a boundary line between the first location and the second location; and a receiver that receives the ultrasonic waves that have passed through the inspection target region.

### BRIEF DESCRIPTION OF THE DRAWINGS

FIG. 1 is a block diagram showing the configuration example of an ultrasonic inspection system 1 to which an ultrasonic inspection device 20 of the embodiment is applied.

FIG. 2 is a cross-sectional view showing a transmitter 26 and a receiver 28 in the embodiment.

FIG. 3 is a plan view showing the transmitter 26 and a receiver 28 of FIG. 2.

FIG. 4 is a schematic drawing showing the relationship between the inspection location of the inspection object 40 and the inspection direction in the embodiment.

FIG. 5 is a drawing for explaining the process performed by ultrasonic inspection device 20 in a modification of the embodiment.

FIG. 6 is a drawing showing the inspection result in a modification of the embodiment.

### DETAILED DESCRIPTION OF THE INVENTION

Hereinafter, embodiments of the present invention will be described with reference to the drawings.

### Embodiment

First, an embodiment will be described.

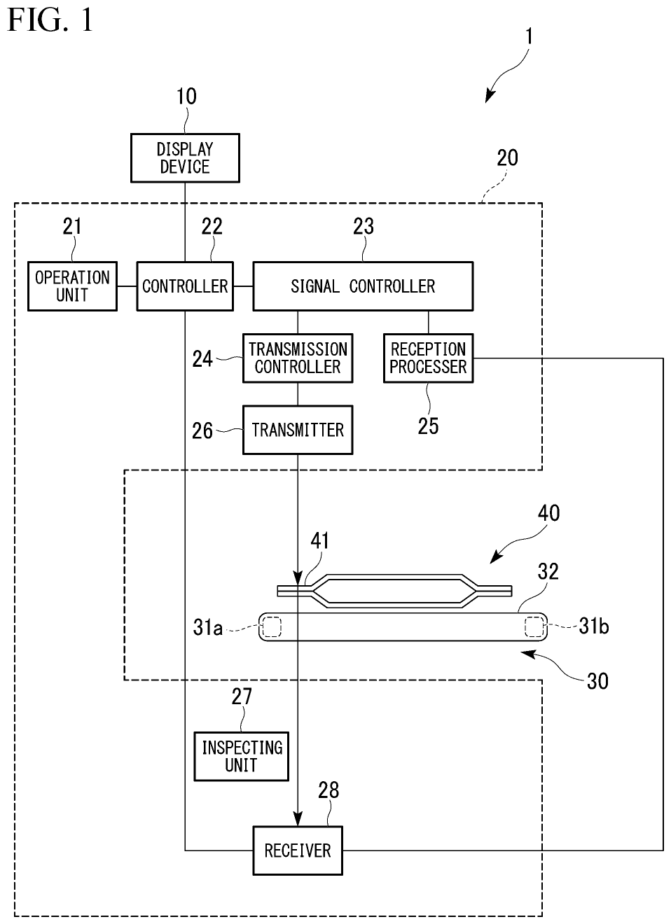

FIG. 1 is a block diagram showing a configuration example of an ultrasonic inspection system 1 in the embodiment. The ultrasonic inspection system 1 inspects an inspection object 40 using ultrasonic waves. In the example illustrated in FIG. 1, the ultrasonic inspection system 1 includes a display device 10, an ultrasonic inspection device 20, and a conveying device 30.

The display device 10 displays various types of information related to the ultrasonic inspection. The information is supplied to the display device 10 from a controller 22 of the ultrasonic inspection device 20. The various types of information related to ultrasonic inspection include, for example, information related to the inspection object 40, the wavelength and intensity of the ultrasonic waves to be transmitted, the speed of transporting the inspection object 40, the analysis result for the received ultrasonic waves, and the determination result with regard to the presence or absence of peeling.

The conveying device 30 is, for example, a belt conveyor. In the conveying device 30, the inspection object 40 is placed on a belt 32. In the conveying device 30, the inspection object 40 is conveyed to a predetermined inspection position between the transmitter 26 and the receiver 28 by rotating rollers 31 (roller 31a and roller 31b). The rotation of the rollers 31 is controlled by, for example, a drive control unit (not shown) of the ultrasonic inspection device 20.

The inspection object 40 is an object subject to inspection by the ultrasonic inspection device 20. The inspection object 40 is, for example, a packaging container formed by joining peripheral edge portions of sheet members. The location to be inspected of the inspection object 40 in the inspection for the presence or absence of peeling is, for example, a peripheral portion 41. The peripheral portion 41 is a location to be joined at which two sheet members constituting the packaging container should be joined.

The ultrasonic inspection device 20 is a computer that transmits ultrasonic waves and inspects the inspection object 40 on the basis of the ultrasonic waves that have passed through the inspection object 40. The ultrasonic inspection device 20 includes, for example, an operation unit 21, the controller 22, a signal controller 23, a transmission controller 24, a reception processer 25, the transmitter 26, the inspecting unit 27, and the receiver 28.

The ultrasonic inspection device 20 is a computer including a processor such as a central processing unit (CPU) and program memory for storing a program executed by the processor. The functional units (an operation unit 21, a controller 22, a signal controller 23, a transmission controller 24, a reception processer 25, the transmitter 26, the inspecting unit 27 and the receiver 28) constituting the ultrasonic inspection device 20 are realized by a processor such as the CPU executing a program stored in the program memory. Some or all of these functional units may be realized by a hardware circuit such as a dedicated Large Scale Integration (LSI), Integrated Circuit (ASIC), or Field-Programmable Gate Array (FPGA).

The operation unit 21 includes a keyboard, a mouse, and the like, and is used to input and set various types of information related to ultrasonic inspection. The operation unit 21 outputs, to the controller 22, the various types of information that have been input.

The controller 22 comprehensively controls the ultrasonic inspection device 20. The controller 22 transmits, for example, various types of information input from the operation unit 2, to the display device 10. The controller 22 also transmits, to the display device 10, an analysis result and a result of determining the presence or absence of peeling from the signal controller 23, which are described below.

The signal controller 23 generates a signal for controlling the ultrasonic waves to be transmitted. The ultrasonic waves to be transmitted are, for example, burst signals. The signal controller 23 generates, for example, a burst signal according to the transmission timing and intensity of the ultrasonic waves to be transmitted. The signal controller 23 supplies the generated signal to the transmission controller 24.

Further, the signal controller 23 acquires, via the reception processer 25, the ultrasonic wave signal that has been received by the receiver 28. The signal controller 23 analyzes the intensity and the phase of the acquired ultrasonic wave signal, and outputs the analysis result to the controller 22. Further, the signal controller 23 outputs to the controller 22 the result of determining the presence or absence of peeling (presence or absence of a defect in the peripheral portion) on the basis of the analyzed result. For example, when the intensity of the acquired ultrasonic wave signal is less than a predetermined value, the signal controller 23 determines peeling to have occurred, that is, the peripheral portion is defective. When the intensity of the acquired ultrasonic wave signal is equal to or greater than a predetermined value, the signal controller 23 determines peeling to have not occurred, that is, the peripheral portion is not defective.

When analyzing the intensity and the phase of the acquired ultrasonic wave signal, the signal controller 23 may extract a signal of a predetermined time segment and analyze the intensity and the phase using the extracted signal. If the state of the ultrasonic waves changes in the time domain, by using ultrasonic waves in a certain time segment that is useful for highly accurate analysis, it is possible to improve the accuracy of the determination. For example, the signal controller 23 extracts, from a signal corresponding to the ultrasonic waves received by the receiver 28, a signal of a predetermined time segment, and analyzes the wavelength and intensity of the extracted signal. The predetermined time segment is a time period that starts from a point in time when the receiver 28 has detected the signal, and is, for example, a time segment corresponding to one wavelength of the transmitted ultrasonic waves.

The signal controller 23 may perform signal processing such as phase detection on the acquired ultrasonic wave signal. In a case where ultrasonic waves with mutually different phases are mixed among the acquired ultrasonic waves, by separating ultrasonic waves having different phases from each other, it is possible to improve the determination accuracy.

The transmission controller 24 generates burst waves of a predetermined frequency to be output from an oscillator (not shown) according to a burst signal from the signal controller 23. The transmission controller 24 outputs the generated burst waves to the transmitter 26.

The reception processer 25 acquires the ultrasonic waves received by the receiver 28 and performs processing to facilitate analysis of the acquired ultrasonic waves. For example, the reception processer 25 amplifies the amplitude of the acquired ultrasonic waves using an amplifier. In addition, the reception processer 25 may filter out, from the acquired ultrasonic waves, ultrasonic waves whose wavelength is different from the wavelength of the transmitted ultrasonic waves.

The transmitter 26 transmits the burst waves (ultrasonic waves) generated by the transmission controller 24.

The receiver 28 receives the ultrasonic waves transmitted by the transmitter 26. The receiver 28 supplies the received ultrasonic waves to the reception processer 25.

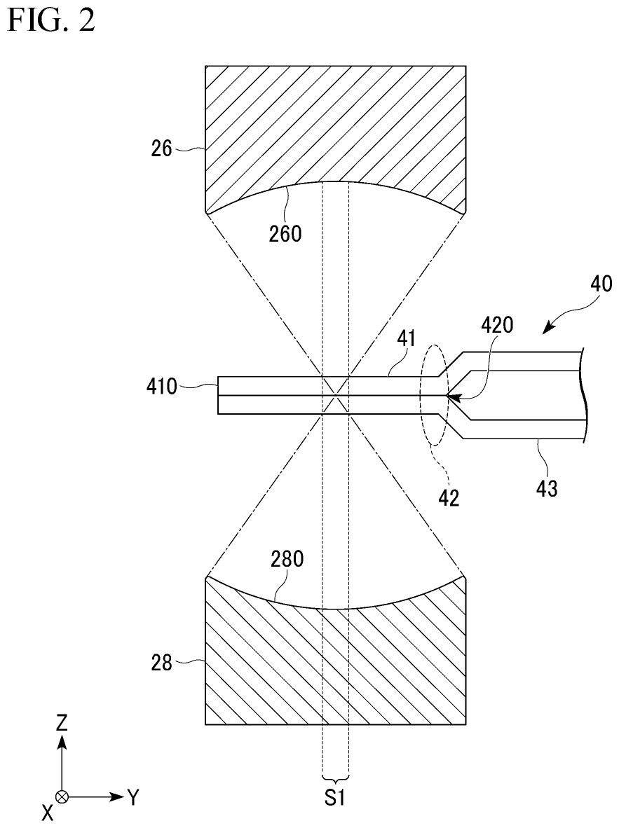

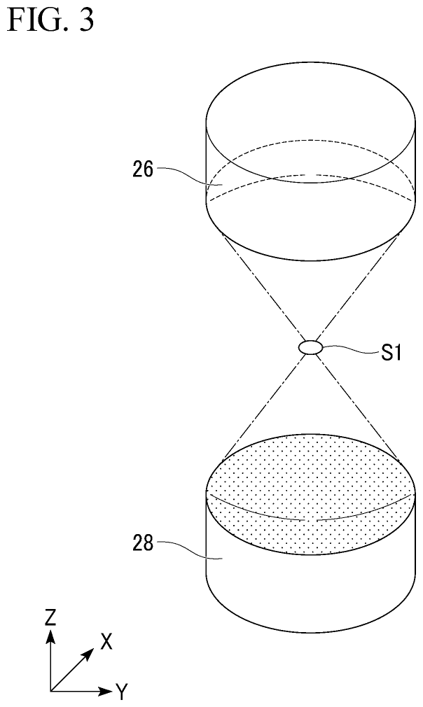

Here, the positional relationship between the transmitter 26, the receiver 28, and the inspection object 40 will be described with reference to FIGS. 2 and 3.

As shown in FIG. 2, the transmitter 26 and the receiver 28 are spaced apart in one direction (Z-axis direction). The transmitter 26 and the receiver 28 are fixed to a base (not shown) of the ultrasonic inspection device 20. Thereby, the interval between the transmitter 26 and the receiver 28 is maintained. The transmitter 26 transmits ultrasonic waves toward the receiver 28 from a transmitting surface 260 of the transmitter 26 facing the receiver 28. The receiver 28 receives the ultrasonic waves transmitted from the transmitter 26 at a receiving surface 280 of the receiver 28. The receiving surface 280 faces the transmitter 26.

In FIG. 2, the conveying direction of the inspection object 40 by the conveying device 30 is the X-axis direction. The conveying direction is a direction orthogonal to the arrangement direction (Z-axis direction) of the transmitter 26 and the receiver 28.

Further, an end portion 410 of the inspection object 40 corresponds to the edge of the inspection object 40. A boundary line 420 of the inspection object 40 indicates the boundary line between a location to be joined (first location) and a location not to be joined (second location). In the example of FIG. 2, the boundary line 420 is a line extending in parallel with the XY plane.

As shown in FIG. 3, the receiver 28 of the present embodiment is formed in a circular shape when viewed from the arrangement direction in which the transmitter 26 and the receiver 28 are arranged. The transmitter 26 of the present embodiment may be formed in the same circular shape as the receiver 28. The transmitting surface 260 of the transmitter 26 forms a recess from the circular peripheral edge portion toward the central portion. With this configuration, the ultrasonic waves transmitted from the transmitter 26 are converged (focused) in a predetermined range. The shapes of the transmitter 26 and the receiver 28 are not limited to a circular shape. The transmitter 26 and the receiver 28 may be formed in arbitrary shapes.

As described above, the transmitter 26 and the receiver 28 are arranged spaced apart from each other. The inspection object 40 is disposed between the transmitter 26 and the receiver 28. The ultrasonic waves transmitted by the transmitter 26 reach the inspection object 40, and the ultrasonic waves that have passed through the inspection object 40 (hereinafter, referred to as object waves) reach the receiver 28 and the receiver 28 receives the object waves.

When ultrasonic waves are transmitted to the peripheral portion 41 of the inspection object 40, diffracted waves resulting from the ultrasonic waves wrapping around the outer side of the peripheral portion 41 may be generated. Such diffracted waves are considered to reach the receiver 28 directly without passing through the inspection object 40. In this case, ultrasonic waves that have not passed through the inspection object 40 (hereinafter referred to as non-object waves) are received by the receiver 28. In this case, inspection is performed using the ultrasonic waves including the non-object waves, which may be a cause of a reduction in inspection accuracy.

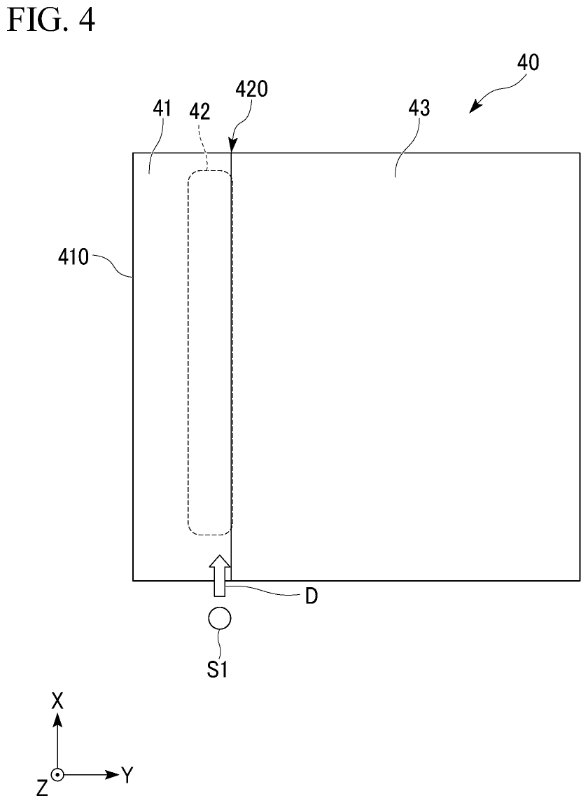

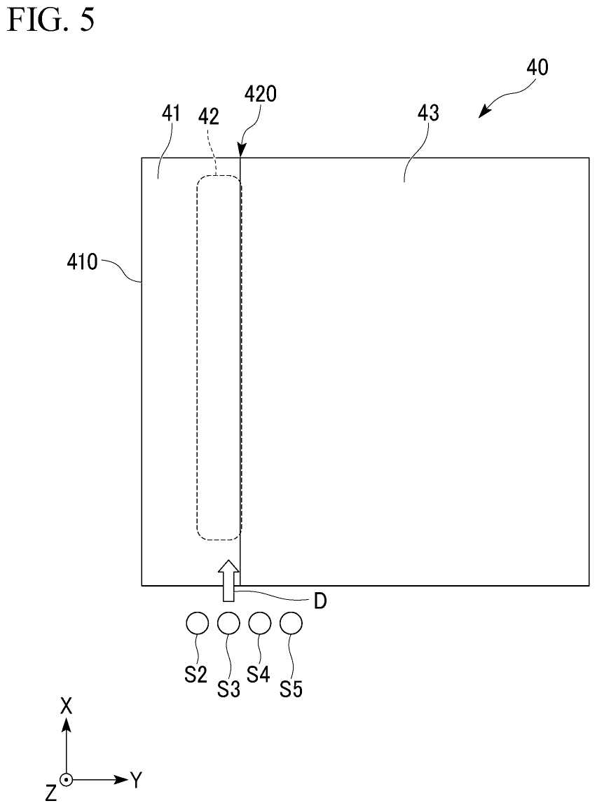

The inspecting unit 27 inspects the inspection object 40 in such a manner that such non-object waves are not easily received by the receiver 28. Hereinafter, the method of the inspection performed by the inspecting unit 27 will be described with reference to FIG. 4 and FIG. 5.

FIG. 4 shows an example in which the inspection object 40 disposed in the XY plane as viewed from above.

An arrow D (X-axis positive direction) in FIG. 4 indicates the direction of the ultrasonic inspection. Ultrasonic waves are transmitted in the Z-axis direction orthogonal to the XY plane.

A region S1 indicates a region irradiated with ultrasonic waves when the transmitted ultrasonic waves reach the XY plane. In other words, the region S1 is the inspection location to be inspected in the ultrasonic inspection. The inspection location (region S1) moves on the inspection object 40 as the inspection object 40 is conveyed by the conveying device 30. The path of movement at the inspection location on the inspection object 40 is the inspection target region to be inspected in the ultrasonic inspection.

As shown in FIG. 4, the inspecting unit 27 controls the position and the movement of the transmitter 26 and the receiver 28, or the inspection object 40. Among the peripheral portion 41 of the inspection object 40, a boundary region 42 serves as the inspection target region. The boundary region 42 is a partial region in the location to be joined that is the peripheral portion 41, and is determined according to the boundary line 420 between the location to be joined and the location not to be joined. The location not to be joined in this case is, for example, a content portion 43. The content portion 43 is located on the inner side (the Y-axis positive direction) of the inspection object 40 from the peripheral portion 41 of the inspection object 40. The boundary line 420 is generated by the joining of the peripheral portion 41 of the inspection object 40 using a joining device (not illustrated).

A case is described in which the width of the joining (hereinafter, joining width) is determined in advance. In this case, the inspecting unit 27 detects the end portion 410 of the inspection object 40, and regards, as the boundary line 420, a position separated inward (in the Y-axis positive direction) from the detected end portion 410 by the distance of the predetermined joining width.

Another case is described in which the joining width changes in accordance with the position of the end portion 410 of the inspection object 40. In this case, the inspecting unit 27 may acquire, from the joining device or a storage (not shown), joining information indicating the relationship between the position of the end portion 410 and the joining width at that position.

The inspecting unit 27 detects the end portion 410 of the inspection object 40, and acquires the joining width in the end portion 410 that was detected by referring to joining information based on the position coordinates of the detected end portion 410. The inspecting unit 27 regards, as the boundary line 420, a position separated from the end portion 410 to the inside (in the Y-axis positive direction) by the distance of the joining width acquired on the basis of the joining information.

For example, a camera may image from above the inspection object 40 placed on the conveying device 30, and the inspecting unit 27 may detect the position of the end portion 410 from the image data of the inspection object 40 obtained from the camera. Alternatively, the inspecting unit 27 may determine the position of the boundary line 420 from the image data of the inspection object 40 obtained from the camera.

The boundary line 420 may have various forms such as a straight line, a curved line, and a wavy line.

The boundary region 42 is a region determined according to the position of the boundary line 420, and is provided on the location to be joined along the boundary line 420. The boundary region 42 is an inspection target region. Therefore, according to the type, size, material, and the like of the inspection object 40, the boundary region 42 is set to a place where detection of peeling is particularly desired. In this example, the boundary region 42 is a region of a predetermined distance from the boundary line 420 in the width direction of the peripheral portion 41 (the Y-axis negative direction). However, the boundary region 42 is not limited to such an example. For example, the boundary region 42 may be a region separated from the boundary line 420 by a predetermined distance in the direction of the end portion 410 (the Y-axis negative direction). Further, while the width in the Y-axis direction in the boundary region 42 may be set arbitrarily, the boundary region 42 needs to be separated from the end portion 410 by a predetermined distance to the inside (the side of the content portion 43). Setting the width of the boundary region 42 to be narrow enables peeling to be detected accurately in a short time. For example, the width in the Y-axis direction of the range in which the ultrasonic waves transmitted from the transmitter 26 are focused on the inspection object 40 may be the width of the boundary region 42. Further, the width of the boundary region 42 may not be uniform.

The inspecting unit 27 causes the inspection to be performed in a direction along the boundary line 420. That is, the inspecting unit 27 makes the conveying direction of the inspection object 40 parallel to the boundary line 420.

In the example of FIG. 4, the boundary line 420 of the inspection object 40 is along the X axis. In this case, the inspecting unit 27 moves the inspection location in the X-axis direction. As long as the inspection location moves relative to the inspection object 40, any other configuration may be adapted. For example, the transmitter 26 and the receiver 28 may be moved instead of conveying the inspection object 40.

As described above, in the ultrasonic inspection device 20 according to the embodiment, the transmitter 26 and the receiver 28 are disposed spaced apart from each other. The inspection object 40 that is formed by the joining of peripheral edge portions of sheet members is disposed between the transmitter 26 and the receiver 28. The transmitter 26 transmits ultrasonic waves to the peripheral portion 41, which is the location to be joined in the inspection object 40. The receiver 28 receives the ultrasonic waves transmitted from the transmitter 26. Thereby, inspection for peeling in the peripheral portion 41 is performed. The ultrasonic inspection device 20 inspects the inspection object 40 in the direction along the boundary line 420, with the boundary region 42 that is set in accordance with the boundary line 420 between the joined location and non-joined location serving as an inspection target region in the peripheral portion 41.

Thereby, in the ultrasonic inspection device 20 according to the embodiment, it is possible to inspect the inner side (the side of the content portion 43) in the width direction of the peripheral portion 41 from the end portion 410 of the peripheral portion 41. That is, it is possible to inspect a location spaced apart from the end portion 410 in the width direction of the peripheral portion 41. For this reason, it is possible to inhibit the generation of diffracted waves which wrap around the end portion 410 compared to the case of inspecting a location near the end portion 410.

In general, ultrasonic waves with a frequency of about 100 kHz to about 3 MHz are often used in accordance with the material of the inspection object 40 and the like in ultrasonic inspection. For example, in the case of inspection for peeling in a packaging container, ultrasonic waves of 400 kHz or 800 kHz are used.

Smaller frequencies (longer wavelengths) of ultrasonic waves tend to diffract. In the following two cases, it is confirmed that non-object waves (diffracted waves) are generated that wrap around the end portion 410 and reach the receiver 28. The first case is the case in which ultrasonic waves have a frequency of 400 kHz and are transmitted to a location about 15 mm to the inside of the inspection object 40 from the end portion 410. The second case is the case where ultrasonic waves have a frequency of 800 kHz and are transmitted to a location about 5 mm to the inside of the inspection object 40 from the end portion 410.

When the inspection object 40 is a general packaging container, the width of the peripheral portion 41 is about 5 mm to 15 mm. In this case, the boundary line 420 in the inspection object 40 is positioned about 5 mm to 15 mm inward in the width direction of the peripheral portion 41 from the end portion 410. When ultrasonic waves are transmitted in the vicinity of the boundary line 420, it is possible to suppress the generation of diffracted waves compared when ultrasonic waves are transmitted to a location near the end portion 410 (for example, a position about 1 mm inward in the width direction of the peripheral portion 41 from the end portion 410).

In consideration of the above, the inspecting unit 27 performs control such that the inspection target region is set to a location which is at least a predetermined distance to the inside in the width direction (Y-axis direction) of the peripheral portion 41 from the end portion 410 of the inspection object 40. Accordingly, the boundary region 42 is provided at a position separated from the end portion 410 by a predetermined distance in the width direction (Y-axis direction) of the peripheral portion 41. The predetermined distance may be determined according to the frequency of the ultrasonic waves used for the inspection. For example, when ultrasonic waves with a frequency of 800 kHz are used for the inspection, the inspecting unit 27 performs the inspection so that at least 5 mm to the inside in the width direction (Y-axis direction) of the peripheral portion 41 from the end portion 410 of the inspection object 40 becomes the inspection location. This enables suppression of the generation of diffracted waves in the ultrasonic inspection.

In the ultrasonic inspection device 20 of the embodiment, the inspection object 40 is inspected in the direction along the boundary line 420. For this reason, compared with the case where inspection is performed in a direction orthogonal to the boundary line 420, it is possible to inspect for the presence or absence of peeling in the region along the boundary line 420 with high accuracy.

For example, it is possible to detect, along the peripheral edge portion, a peeling location in the vicinity of the boundary line 420 that was generated by, for example, sandwiching the enclosed contents when joining the sheet members.

Further, in the ultrasonic inspection device 20 according to the embodiment, the peripheral portion 41 of the inspection object 40 does not need to be supported in a clamped manner. For this reason, it takes less time to prepare for inspection of the inspection object 40, and inspection can be performed efficiently. Moreover, inspection can be easily performed even in the case of a container in which the external shape of the packaging container is complicated.

### First Modification of Embodiment

Next, a first modification of the embodiment will be described. The present modification differs from the above-described embodiment in that a plurality of inspection locations are provided in the width direction (Y-axis direction) of the peripheral portion 41.

FIG. 5 is a schematic view showing the relationship between the inspection locations and the inspection direction of the inspection object 40 in the first modification of the embodiment. The example of FIG. 5 differs from that of FIG. 4 in that a plurality of inspection locations are shown in regions S2 to S5. Other than that, the example of FIG. 5 is the same as that of FIG. 4. Descriptions of the same components as those in FIG. 4 will be omitted.

In the present modification, the transmitter 26 includes, for example, a plurality of transmitting elements that are linearly arranged. More specifically, transmitter 26 includes transmitting elements that are arranged linearly in the width direction (Y-axis direction) of the peripheral portion 41, and transmits ultrasonic waves to the inspection object 40. In the present modification, a plurality of inspection locations are provided such that the regions S2 to S5 are aligned in the width direction (Y-axis direction) of the peripheral portion 41 of the inspection object 40.

The inspecting unit 27 inspects the inspection object 40 such that the boundary region 42 is included in the inspection target region, which is the path along which each of the inspection locations have moved. That is, also in the present modification, the boundary region 42 is the inspection target region.

The inspecting unit 27 controls the movement of the inspection object 40 so that the inspection is performed in a direction following the boundary line 420 at each inspection location.

When the transmitter 26 includes a single transmitting element and transmits ultrasonic waves at a single point, the inspecting unit 27 may perform a plurality of inspections in a direction following the boundary line 420 while moving the inspection location. For example, the inspecting unit 27 inspects the inspection object 40 such that, for one inspection location (for example region S2), the inspection is performed in a direction following the boundary line 420, and after the inspection in the direction following the boundary line 420 is completed, the inspection location is moved in the width direction of the peripheral portion 41 (for example, to region S3). By repeating this operation a plurality of times, the inspecting unit 27 inspects a plurality of inspection locations in the width direction (Y-axis direction) of the peripheral portion 41 in the direction along the boundary line 420. Here, the interval between the inspection locations may be arbitrarily set according to the inspection object 40.

The transmitter 26 may also be a transmitter that transmits linearly converged ultrasonic waves.

As described above, in the ultrasonic inspection device 20 of the present modification, the inspecting unit 27 inspects the inspection object 40 so that the inspection is performed in the peripheral portion 41 in a direction following the boundary line 420 at a plurality of inspection locations along the width direction of the peripheral portion 41. Thereby, in the ultrasonic inspection device 20 of this modification, in addition to the advantageous effects of the embodiment described above, in the case where there is peeling in a region along the boundary line 420, it is possible to detect the length of the peeling in the width direction of the peripheral portion 41 (the width of the peeled region). When the width of the peeled region is detected, it is possible to determine whether or not there is a risk of the contents stored in the packaging container leaking, and it is possible to accurately determine whether the product is defective or not.

### Second Modification of Embodiment

Next, a second modification of the embodiment will be described. The present modification differs from the embodiment described above in that the controller (data processor) 22 processes the inspection result into data.

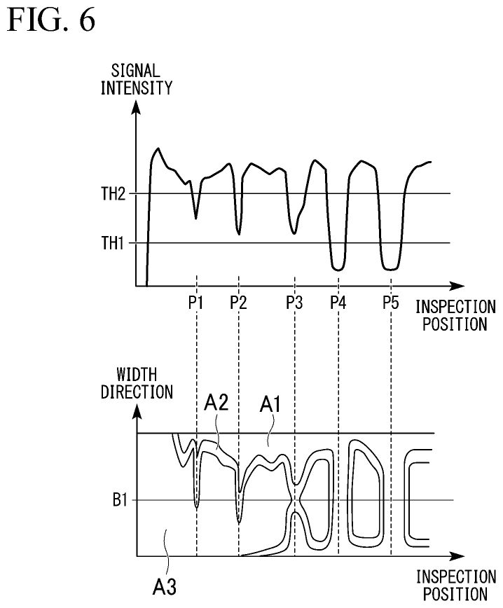

FIG. 6 is a drawing showing an example of the inspection result in the present modification.

The upper graph of FIG. 6 shows the relationship between the signal intensity of the received ultrasonic waves and the inspection position. The lower graph shows the presence or absence of peeling at positions corresponding to the upper graph (position B1 in the width direction in this graph).

As shown in the upper graph of FIG. 6, in ultrasonic inspection, the signal intensity of the received ultrasonic waves may differ depending on the inspection position. This is because the intensity of the ultrasonic waves that have passed through the inspection object differ between the case where peeling has occurred and the case where peeling has not occurred in the inspection target region. In this example, the signal intensity is less than intensity TH1 at inspection positions P4 and P5. At inspection positions P1 to P3, the signal intensity is equal to or greater than the intensity TH1 and less than the intensity TH2. In this example, when the signal intensity of the received ultrasonic waves is small, it is determined that peeling has occurred in the corresponding inspection object.

When the relationship between the signal intensity and the inspection location as shown in the upper graph of FIG. 6 is detected at the position B1 in the width direction, a plot is made in a color corresponding to the signal intensity in the lower graph of FIG. 6. An inspection position at which the signal intensity is less than the intensity TH1 is indicated by a specific color A1 (for example, gray). An inspection position at which the signal intensity is equal to or greater than the intensity TH1 and less than the intensity TH2 is indicated by a color A2 different from the color A1 (for example, yellow). An inspection position at which the signal intensity is equal to or greater than the intensity TH2 is indicated by a color A3 (for example, orange) different from the colors A1 and A2.

If the above plot is performed at a plurality of different inspection positions in the width direction, as shown in the lower graph of FIG. 6, peeling is observed to occur at nearly all positions in the width direction at inspection positions P4 and P5. The inspection position P3 is in a state close to peeling at position B1 in the width direction, while peeling is indicated to have occurred at nearly all positions other than position B1 in the width direction.

In the present modification, the ultrasonic inspection device 20 performs inspection in a direction along the boundary line 420 at each of a plurality of inspection locations along the width direction (Y-axis direction) of the peripheral portion 41. The ultrasonic inspection device 20 acquires the relationship between the signal intensity and the inspection position as shown in the upper graph of FIG. 6 for each inspection location.

Thereby, when ultrasonic waves are transmitted in the direction along the boundary line 420 at a plurality of inspection locations, the ultrasonic inspection device 20 acquires an inspection result (for example, data corresponding to the upper graph of FIG. 6) showing the relationship between the signal intensity of the received ultrasonic waves and the inspection location.

The controller 22 processes the inspection result into data indicating the relationship between the location in the width direction of the peripheral portion 41 and the presence or absence of peeling according to the location in the width direction. For example, the controller 22, in correspondence with the location in the width direction of the peripheral portion 41 at each inspection position, plots the relationship between the signal intensity and the inspection position at the location in a color according to the signal intensity (for example, the data according to the lower graph of FIG. 6).

As described above, when ultrasonic waves are transmitted in the direction along the boundary line 420 at a plurality of inspection locations, the controller 22 of the ultrasonic inspection device 20 of the present modification processes (generates) the inspection result showing the relationship between the received signal strength and the inspection position into data indicating the relationship between the location in the width direction of the peripheral portion 41 and the presence or absence of peeling according to the location in the width direction.

Thereby, in the ultrasonic inspection device 20 of this modification, the presence or absence of peeling in the width direction (Y-axis direction) of the peripheral portion 41 can be easily recognized and presented. For example, when plotting in different colors for each of the received signal intensities, it is possible to visually recognize at what position in the width direction of the peripheral portion 41 the peeling is occurring at what width.

According to one embodiment, it is possible to inspect for peeling at a joined portion of an inspection object without prolonging the inspection time.

While preferred embodiments of the invention have been described and illustrated above, it should be noted that these embodiments are exemplary of the invention and are not to be considered as limiting. These embodiments can be implemented in other various forms, and additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An ultrasonic inspection method for inspecting an inspection object including sheet members having peripheral portions, the peripheral portions being joined together at a first location, and the sheet members being not joined together at a second location which is adjacent to the first location, the method comprising:
outputting ultrasonic waves to an inspection target region in the peripheral portions, the inspection target region being set according to a boundary line between the first location and the second location; and
receiving the ultrasonic waves that have passed through the inspection target region.

2. The ultrasonic inspection method according to claim 1, wherein the outputting the ultrasonic waves comprises outputting ultrasonic waves at each of a plurality of inspection locations while a position of the peripheral portions through which ultrasonic waves passes changes along the boundary line, the plurality of inspection locations being arranged in a width direction of the peripheral portions that is orthogonal to the boundary line.

3. The ultrasonic inspection method according to claim 2, further comprising:
generating data showing a relationship between positions of the peripheral portions and presence or absence of a defect in the positions, by using a relationship between the positions and signal intensities of the ultrasonic waves that have passed the positions, the positions being arranged along the width direction.

4. The ultrasonic inspection method according to claim 1, further comprising:
setting, as the inspection target region, a location that is at least a predetermined distance to inside in a width direction of the peripheral portions from an end of the peripheral portions, the width direction being orthogonal to the boundary line.

5. The ultrasonic inspection method according to claim 4, further comprising:
determining the predetermined distance in accordance with a frequency of the ultrasonic waves.

6. An ultrasonic inspection device for inspecting an inspection object including sheet members having peripheral portions, the peripheral portions being joined together at a first location, and the sheet members being not joined together at a second location which is adjacent to the first location, the device comprising:
a transmitter that outputs ultrasonic waves to an inspection target region in the peripheral portions, the inspection target region being set according to a boundary line between the first location and the second location; and
a receiver that receives the ultrasonic waves that have passed through the inspection target region.

7. The ultrasonic inspection device according to claim 6, wherein the transmitter outputs ultrasonic waves at each of a plurality of inspection locations while a position of the peripheral portions through which ultrasonic waves passes changes along the boundary line, the plurality of inspection locations being arranged in a width direction of the peripheral portions that is orthogonal to the boundary line.

8. The ultrasonic inspection device according to claim 7, further comprising:
a controller that generates data showing a relationship between positions of the peripheral portions and presence or absence of a defect in the positions, by using a relationship between the positions and signal intensities of the ultrasonic waves that have passed the positions, the positions being arranged along the width direction.

9. The ultrasonic inspection device according to claim 6, further comprising:
an inspecting unit that sets, as the inspection target region, a location that is at least a predetermined distance to inside in a width direction of the peripheral portions from an end of the peripheral portions, the width direction being orthogonal to the boundary line.

10. The ultrasonic inspection device according to claim 9, wherein the inspecting unit determines the predetermined distance in accordance with a frequency of the ultrasonic waves.
